(19) United States
(12) Patent Application Publication
(10) Pub. No.: US 2004/0165397 A1
(43) Pub. Date: Aug. 26, 2004

(54) Automotive interior mirror module with proximity switch

(76) Inventors: Helmut Bentivoglio, Blaubeuren (DE); Volker Zipf, Plochingen (DE)

Correspondence Address: Warn, Burgess & Hoffmann, P.C., P.O. Box 70098, Rochester Hills, MI, 48307, US

(21) Appl. No.: 10/607,923

(22) Filed: Jun. 27, 2003

(30) Foreign Application Priority Data
Jul. 2, 2002 (DE) 102 29 590.5

(51) Int. Cl. B60R 1/12

(52) U.S. Cl. 362/494

(57) ABSTRACT

The invention relates to a switching device for at least one switching function on the housing or base of an automotive interior mirror module. To this end, at least one sensor or a sensor array is arranged on the housing or base of the automotive interior mirror module. The sensor or sensor array, in combination with internal or external evaluation electronics, initiates at least one switching process based on the approach of a nonmetallic object as a switching element.

The present invention develops a switching device for an automotive interior mirror module that permits simple, reliable operation of the device's switching element.

The invention relates to a switching device for at least one switching function on the housing or base of an automotive interior mirror module.

At the present time, automotive interior mirrors have many other functions in addition to the rearview function, including the functions of a sensor carrier for rain, acoustic signals, navigation, temperature, barometric pressure, time, as a display device for internal and external vehicle data, as an infrared transmitter for garage door openers, and much more. As an automotive interior mirror module, the interior mirror in its role as component carrier is connected to the on-board electronics by a cable harness.

Moreover, in some types of vehicles the automotive interior mirror is additionally used with pushbuttons for the antiglare function and for turning reading lamps on and off, such as in the Mercedes-Benz M-Class, 1999 model year. In darkness, the pushbuttons located in the lower section of the mirror housing must be identified by touch. In addition, pushing a button roughly can move the interior mirror out of adjustment.

Consequently, the problem that the present invention aims to solve is the development of a switching device for an automotive interior mirror that permits simple, reliable operation of the switching elements of the device.

This problem is solved with the features of the first claim. To this end, at least one sensor or a sensor array is arranged on the housing or base of the automotive interior mirror module. The sensor or sensor array, in combination with internal or external evaluation electronics, initiates at least one switching process based on the approach of a nonmetallic object as a switching element. At least one consumer located in the vehicle is set in operation or turned off by means of this switching process.

The switching device achieves touchless activation of a function by simple approach to the automotive interior mirror module, without touching a mechanical switch. For example, if the driver or passenger wishes to turn his reading lamp on or off, this is accomplished through an intuitive operation using the switching device in that the person doing the switching activates the applicable triggering sensor or sensor array by moving his hand near it. This eliminates the need to search for the reading lamp switch by feel, which is especially inconvenient in the dark. Moreover, the region of effective sensor sensitivity is significantly larger than with a conventional commercial mechanical pushbutton, where the region of sensitivity is limited to only the pushbutton surface itself as the operating element area. In the immediate vicinity of the automotive interior mirror module housing, the region of sensitivity of the individual sensor is approximately 20 times larger than the operating element area of the aforementioned mechanical pushbutton, for example.

The sensor or sensor array is designed as a film or other spatial structure, for example. The structure here can also be a grid or a wire element as a simple antenna. There are also sensors whose space requirements are on the same order of magnitude in all three coordinate directions.

An example of a possible sensor array in the switching device is a group of sensors of the same type or a combination of different—possibly complementary—types of sensors.

The sensor or sensors can be placed at any desired locations within the automotive interior mirror module housing. They can also be placed or integrated directly behind the mirror glass, possibly attached thereto by gluing, vapor-deposition, or similar process. Another alternative is direct molded-in integration into the plastic housing of the automotive interior mirror module.

In order to arrange a fairly large number of sensors in the automotive interior mirror module, the individual sensors or the array of sensors can be provided with an appropriate directivity. In the extreme case, the automotive interior mirror module then has, for example, a surrounding sensitive area in the form of a hemisphere or partial ellipsoid, which represents for example a double-digit number of switching functions.

The switching device can be provided with a sensitivity adjustment if desired. This can be used to set the length of the desired approach distance. In this way, each driver or passenger has comparable operating convenience regardless of physical size or preferred seat position. The sensitivity setting can be influenced by means such as a manually operated potentiometer or adjusting wheel, a sensor that is sensitive to ambient light level, or a scanner or sensor that detects physical size and/or seat position. A separate manual shutoff for the switching device is also conceivable.

Further details of the invention may be found in the dependent claims and in the description below of two example embodiments shown schematically.

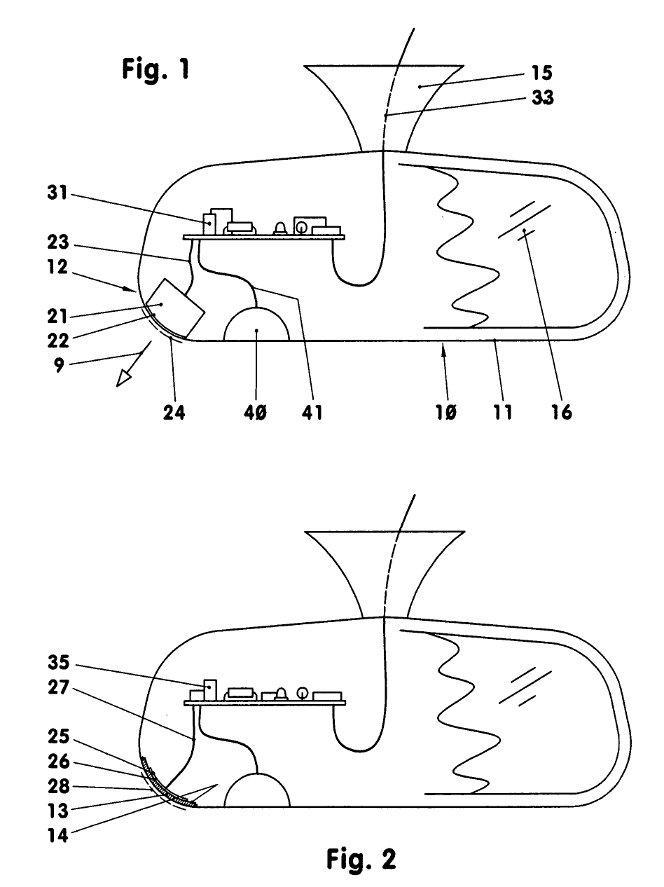

FIG. 1: automotive interior mirror module with proximity switch;

FIG. 2: automotive interior mirror module with combined proximity and touch switch.

FIGS. 1 and 2 each show, by way of example, an automotive interior mirror module (10) with at least one sensor (21, 25), at least one evaluation electronics unit (31, 35), and at least one reading lamp (40). The sensor (21, 25), in combination with the evaluation electronics (31, 35), serves to turn an end consumer, for example in the form of a reading lamp (40), on and off.

The automotive interior mirror module (10) generally has a rigid housing (11), which normally is attached by means of a mirror base (12), for example in the region of the roof or instrument panel. The housing (11) contains, behind the mirror (16), the sensors (21, 25), the reading lamp (40), and the evaluation electronics (40). In addition to the reading lamp (40), the housing (11) can also accommodate items such as microphones, a compass, a headlight dimmer, a moisture/rain sensor, a radar receiver, a garage door opener, a navigation sensor, an information display, a remote door opener, etc.

In FIG. 1, a proximity sensor (21) for distances in the low decimeter range is located in the lower left corner region (12) of the housing (11). This proximity sensor can be a capacitive sensor, for example. In such a sensor (21), the capacitance of an active surface (22) with respect to its surroundings is used as a frequency-determining capacitor in an RC or LC signal generator. Every change in its surroundings influences the field pattern and thus the capacitance, and is immediately reflected in a corresponding frequency change. Thus, when a nonmetallic object, for example the driver's hand, approaches the surface (22) that serves as a receiving element, the subsequent evaluation electronics unit (31) detects a capacitive detuning. When the magnitude of this detuning reaches a presettable threshold value, the evaluation electronics unit generates a switching signal that can be further processed.

In the event of a similar repeated approach, this switching signal is produced again. Depending on the design of the evaluation electronics unit (31), a first approach can be interpreted as a turn-on command and a second approach as a turn-off command, for example. The evaluation electronics unit (31) can directly control the end consumer, for example the reading lamp (4), or can transmit the switching information to a control unit that is physically remote.

In order to prevent unstable switching behavior in the event of a slow approach, the threshold value is provided with a hysteresis region.

The proximity sensor (21) can also be a passive infrared sensor such as is integrated in ordinary commercial motion detectors. In the present case, this sensor detects the body heat of the moving hand. The driver can even wear gloves in this case. All sensor types mentioned detect the approaching hand in spite of gloves.

The proximity sensor (21) can if necessary be a radar motion detector.

The function of the proximity sensor (21) can also be based on an acoustic principle of operation. Such a sensor (21) transmits a train of ultrasound pulses, for example, and detects the echo. The distance is calculated from the time difference between the transmission and the reception. In this way, the distance of objects can be detected with great precision regardless of shape, color or material.

FIG. 2 shows a capacitive proximity sensor (25) that is particularly sensitive in the millimeter range. Here, the positive capacitor plate is a sensor film (26) arranged on the inner wall (14) of the housing wall (13), while the vehicle floor, seats and dashboard form the negative capacitor plate. The driver forms the dielectric. When the driver moves his hand in the vicinity of, or touches, the housing corner (12) behind which the sensor film or plate (26) is located the evaluation electronics unit initiates a switching signal which causes the reading lamp (40) to be alternately switched on and off, for example.

The evaluation electronics units (31, 35) can of course also be integrated into the sensors (21, 25) or can be arranged in the vicinity of the sensors (21, 25) as separate assemblies.

### List of Reference Numbers

9 Direction of directivity

10 Automotive interior mirror module

11 Mirror housing

12 Mirror housing corner

13 Housing wall

14 Housing inner wall

15 Mirror base

16 Mirror

21 Proximity sensor

22 Active sensor surface

23 Signal line

24 Sensitive area in the region of the outer surface of the housing (11)

25 Proximity sensor, touch sensor

26 Sensor surface

27 Signal line

28 Sensitive area in the region of the outer surface of the housing (11)

31, 35 Evaluation electronics

33 Supply line from on-board network

49 Reading lamp

41 Reading lamp line to (31, 35)

1. Switching device for at least one switching function on the housing or base of an automotive interior mirror module, characterized in that
arranged on the housing (11) or base (15) of an automotive interior mirror module (10) is at least one sensor (21, 25) or a sensor array, which, in combination with an internal or external evaluation electronics unit (31, 35), initiates at least one switching process based on the approach of a nonmetallic object as a switching element.

2. Switching device from claim 1, characterized in that the evaluation electronics unit (31, 35) generates a turn-on signal from a first approach and generates a turn-off signal from a second approach.

3. Switching device from claim 2, characterized in that a reading lamp (40) integrated in the housing (11) is turned on and off by the turn-on and turn-off signals.

4. Switching device from claim 1, characterized in that the automotive interior mirror module (10) has a mirror base (15).

5. Switching device from claim 1, characterized in that the evaluation electronics unit (31, 32) is located in the mirror housing (11) or in the mirror base (15).

6. Switching device from claim 1, characterized in that the sensor (21, 25) or the sensor array is provided with a preferred directivity.

7. Switching device from claim 1, characterized in that it is provided with a sensitivity adjustment that is used to set the length of the desired approach distance.

8. Switching device for at least one switching function on the housing or base of an automotive interior mirror module, characterized in that
arranged on the housing (11) of an automotive interior mirror module (10) is at least one sensor (25) or a sensor array, which, in combination with an internal or external evaluation electronics unit, initiates at least one switching process based on the force-free touch of a nonmetallic object as a switching element.

9. Switching device from claims 1, characterized in that the sensor (21, 25) or sensor array is located in the lower corner region (12) of the housing (11) facing the driver.

10. Switching device from claims 1, characterized in that the sensitive area (24, 28) of the sensor (21, 25) or sensor array is at least ten times the size of a conventional mechanical pushbutton.
